(19) United States
(12) Patent Application Publication
(10) Pub. No.: US 2026/0181454 A1
(43) Pub. Date: Jun. 25, 2026

(54) CONFIGURING A TRANSMISSION FOR RECEPTION AT AN ASSOCIATED STATION AND AN UNASSOCIATED STATION

(71) Applicant: Samsung Electronics Co., Ltd., Suwon-si (KR)

(72) Inventors: Bilal Sadiq, Plano, TX (US); Vishnu Vardhan Ratnam, Frisco, TX (US); Yue Qi, Plano, TX (US); Peshal Nayak, Plano, TX (US); Rubayet Shafin, Frisco, TX (US); Boon Loong Ng, Plano, TX (US)

(21) Appl. No.: 19/415,619

(22) Filed: Dec. 10, 2025

Related U.S. Application Data
(60) Provisional application No. 63/736,826, filed on Dec. 20, 2024.
(60) Provisional application No. 63/743,013, filed on Jan. 8, 2025.
(60) Provisional application No. 63/778,585, filed on Mar. 27, 2025.

(51) Int. Cl. H04W 24/10; H04L 1/00; H04W 28/02

(52) U.S. Cl. CPC H04W 24/10; H04L 1/0003; H04W 28/0236

(57) ABSTRACT

Methods and systems for configuring a transmission for reception at an associated station (STA) and an unassociated STA. A non-access point (AP) device includes a transceiver configured to form a link with an associated AP device and a link with an unassociated AP device. The non-AP device also includes a processor operably coupled to the transceiver. The processor is configured to generate a message including a measurement report. The transceiver is further configured to transmit, to the associated AP device and the unassociated AP device, the message using a frame addressed to the associated AP device and configured for reception at the unassociated AP device.

### CROSS-REFERENCE TO RELATED APPLICATIONS AND CLAIM OF PRIORITY

The present application claims priority to U.S. Provisional Patent Application No. 63/736,826, filed on Dec. 20, 2024, U.S. Provisional Application No. 63/743,013, filed on Jan. 8, 2025, and U.S. Provisional Patent Application No. 63/778,585, filed on Mar. 27, 2025. The contents of the above-identified patent documents are incorporated herein by reference.

### TECHNICAL FIELD

The present disclosure relates generally to wireless communication systems. More specifically, the present disclosure relates to a system and method for configuring a transmission for reception at an associated station (STA) and an unassociated STA.

### BACKGROUND

Wireless local area network (WLAN) technology allows devices to access the internet in the 2.4 GHz, 5GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

When a wireless device such as a non-access point (AP) STA is associated with an access point, the device transmits measurement reports, sends data, and receives data through the associated access point. The device addresses frames, including channel state information measurement reports and compressed beamforming reports, to the associated access point, which is the sole intended recipient. The device configures its transmissions for proper reception at the associated access point and does not additionally configure those transmissions for reception at any unassociated access point.

### SUMMARY

The present disclosure relates generally to wireless communication systems and, more specifically, the present disclosure relates to a system and method for configuring a transmission for reception at an associated STA and an unassociated STA.

In one embodiment, a non-AP device is provided. The non-AP device includes a transceiver configured to form a link with an AP device and a link with an unassociated AP device. The non-AP device also includes a processor operably coupled to the transceiver. The processor is configured to generate a message including a measurement report. The transceiver is further configured to transmit, to the associated AP device and the unassociated AP device, the message using a frame addressed to the associated AP device and configured for reception at the unassociated AP device.

In another embodiment, an associated AP device is provided. The associated AP device includes a transceiver configured to form a link with a non-AP device. The associated AP device also includes a processor operably coupled to the transceiver. The processor is configured to configure the non-AP device for transmission to an unassociated AP device. The transceiver is further configured to receive, from the non-AP device, the message in a frame addressed to the non-AP device and configured for reception at the unassociated AP device.

In yet another embodiment, a method of wireless communication performed by a non-AP device is provided. The non-AP device includes a transceiver configured to form a link with an associated AP device and a link with an unassociated AP device. The method includes generating, using the non-AP device, a message including a measurement report, and transmitting, to the associated AP device and the unassociated AP device, the message using a frame addressed to the associated AP device and configured for reception at the unassociated AP device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP device according to embodiments of the present disclosure;

FIG. 2B illustrates an example STA according to embodiments of the present disclosure;

FIG. 3 illustrates an example process for receiving a trigger to perform a measurement according to embodiments of the present disclosure;

FIG. 4 illustrates an example process for an associated AP device configuring a trigged transmission according to embodiments of the present disclosure; and

FIG. 5 illustrates an example flow chart of a method for wireless communication performed by a non-AP device according to embodiments of the present disclosure.

### DETAILED DESCRIPTION

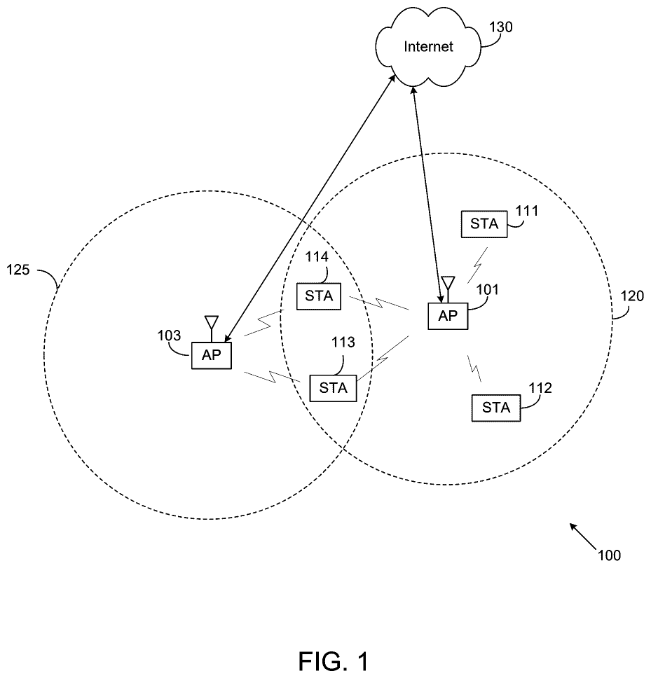

FIG. 1 through FIG. 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, wireless local area network (WLAN) technology allows devices to access the internet in the 2.4 GHz, 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

When a wireless device such as a non-AP device STA is associated with an access point, the device transmits measurement reports, sends data, and receives data through the associated access point. The device addresses frames, including channel state information measurement reports and compressed beamforming reports, to the associated access point, which is the sole intended recipient. The device configures its transmissions for proper reception at the associated access point and does not additionally configure those transmissions for reception at any unassociated access point.

Multiple access points, for example neighboring access points operating on at least one common channel, may coordinate to improve system performance in areas such as data rate, reliability, and latency. For example, two or more access points may coordinate beamforming or precoding decisions for simultaneous transmissions so that each access point can serve its associated STA while reducing interference to the STA served by the other access point at the same time. In another example, two or more access points may coordinate to achieve spatial reuse of the channel by transmitting them to their respective associated STA s that are partly shielded from the other access point because of current channel conditions, the environment, or relative locations.

However, these and other multi-access-point coordination schemes may require, or benefit from, obtaining a measurement report from a STA not only at the associated access point, as is customary, but also at one or more unassociated access points. More generally, a STA may transmit a frame addressed to its associated access point in which at least part of the information needs to be conveyed to at least one unassociated access point for the purpose of enabling multi-access-point coordination. The associated access point, after receiving the frame from the associated STA, may forward the relevant information to an unassociated access point using a backhaul link or a distribution system between access points. This approach may be inefficient, or infeasible if a backhaul link is unavailable.

Accordingly, the present disclosure provides systems and methods for configuring a transmission for reception at an associated STA and an unassociated STA. As described herein, the present disclosure includes systems and methods that may be performed by a non-AP device that includes STAs that each include a transceiver configured to form a link with an associated AP device and an unassociated AP device. The method may include generating, using the non-AP device, a message including a measurement report, and transmitting, to the associated AP device and the unassociated AP device, the message using a frame addressed to the associated AP device and configured for reception at the unassociated AP device.

The present disclosure, thus, provides an alternative that allows for the unassociated access point to obtain the relevant information by directly receiving and decoding, over the air, the STA's transmission to its associated access point. This disclosure provides techniques to enable that mode of operation. For example, the station can use these techniques to configure a measurement report addressed to its associated access point so that both the associated and unassociated access points can receive and correctly decode the transmission. In another example, the associated access point can use these techniques to provide a configuration to the STA, for example in a trigger frame, which the STA then uses for the transmission of a measurement report addressed to the associated access point, enabling both the associated and unassociated access points to receive and correctly decode the transmission. The associated access point and one or more unassociated access points that are part of a coordination group and attempt to receive and decode the STA's transmitted frames, including those containing measurement reports, may be referred to as coordinating access points.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of STAs 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP device,” such as “router” or “gateway.” For the sake of convenience, the term “AP device” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP device STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP device MLDs. Each MLD is affiliated with more than one STA. For convenience of explanation, an AP device MLD is described herein as affiliated with more than one AP device (e.g., more than one AP device STA), and a non-AP device MLD is described herein as affiliated with more than one STA (e.g., more than one non-AP device STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for facilitating configuring a transmission for reception at an associated STA and an unassociated STA. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

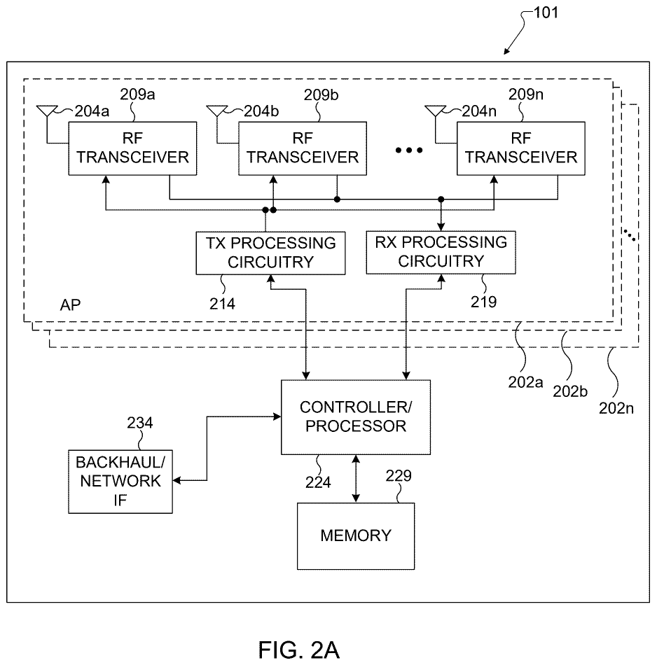

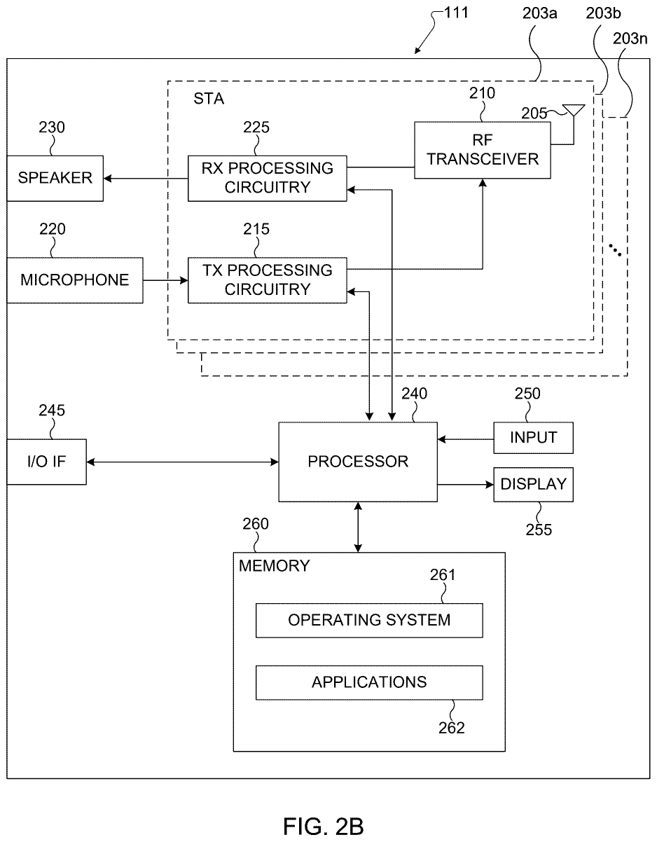

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed herein below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHz, or 6 GHz, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202a-202n operates at a different bandwidth, e.g., 2.4 GHz, 5 GHz, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP device MLD 101 by the controller/processor 224 including facilitating transmission for reception at an associated AP and an unassociated AP. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for configuring a transmission for reception at an associated STA and an unassociated STA. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example non-AP device MLD 111 according to various embodiments of this disclosure. The embodiment of the non-AP device MLD 111 illustrated in FIG. 2B is for illustration only, and the STAs 111-115 of FIG. 1 could have the same or similar configuration. In the embodiments discussed herein below, the STA 111 is a non-AP device MLD. However, STAs come in a wide variety of configurations, and FIG. 2B does not limit the scope of this disclosure to any particular implementation of a STA.

The non-AP device MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP device MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP device MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP device MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate configuring a transmission for reception at an associated AP device and an unassociated AP device. In some embodiments, the controller/processor 240 includes at least one microprocessor or microcontroller.

The processor 240 is also capable of executing other processes and programs resident in the memory 260, such as operations for facilitating transmission for reception at an associated AP and an unassociated AP. The controller/processor 240 can move data into or out of the memory 260 as required by an executing process. In some embodiments, the controller/processor 240 is configured to execute a plurality of applications 262, such as applications for facilitating transmission for reception at an associated AP and an unassociated AP. The controller/processor 240 can operate the plurality of applications 262 based on the OS program 261 or in response to a signal received from an AP device. The main controller/processor 240 is also coupled to the I/O interface 245, which provides non-AP device MLD 111 with the ability to connect to other devices such as laptop computers and handheld computers. The I/O interface 245 is the communication path between these accessories and the main controller 240.

The processor 240 is also coupled to the touchscreen 250 and the display 255. The operator of the non-AP device MLD 111 can use the touchscreen 250 to enter data into the non-AP device MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP device MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP device 101. In another example, the non-AP device MLD 111 may not include voice communication or the controller/processor 240 could be divided into multiple processors, such as one or more central processing units (CPUs) and one or more graphics processing units (GPUs). Also, while FIG. 2B illustrates the non-AP device MLD 111 configured as a mobile telephone or smartphone, non-AP device MLDs can be configured to operate as other types of mobile or stationary devices.

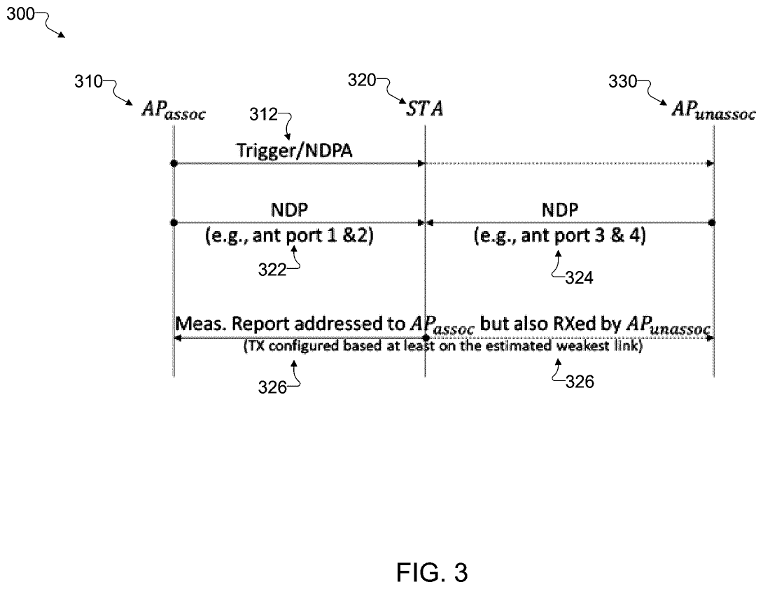

FIG. 3 illustrates an example process 300 for receiving a trigger to perform a measurement according to embodiments of the present disclosure. For ease of explanation, the process 300 will be described as including one or more components of the wireless network 100 of FIG. 1; however, the process 300 could be implemented using any other suitable device or system. The embodiment of the process 300 shown in FIG. 3 is for illustration only. Other embodiments of the process 300 could be used without departing from the scope of this disclosure.

As shown in FIG. 3, the process 300 includes an associated AP device 310, a non-AP device STA 320, and an unassociated AP device 330 communicatively coupled to each other (such as in a wireless network 100). The associated AP device 310 may transmit a trigger 312 to the non-AP device STA 320. The trigger 312 may also have fields addressed to the unassociated AP device 330. In various embodiments, the trigger indicates that training signals for measurement are transmitted in part by the associated AP device and in part by an unassociated AP device. The non-AP device STA 320 also receives a first training signal 322 from the associated AP device 310 and a second training signal 324 from the unassociated AP device 330. In response, the unassociated AP device 330 may transmit a measurement report 326 to the associated AP device 310 and to the unassociated AP device 330.

The non-AP device STA 320 receives a trigger from the associated AP device 310 indicating an upcoming transmission of training signals for measurement, where at least part of the training signals is transmitted by an unassociated AP device 330. In the example shown, the training signals include multiple antenna ports, or spatial streams. Antenna ports 1 and 2 are transmitted by the associated AP device 310, and antenna ports 3 and 4 are transmitted by the unassociated AP device 330. The trigger may specify the correspondence between the AP devices and the antenna ports. The non-AP device STA 320 then performs the measurement on the training signals. The non-AP device STA 320 estimates link quality to the unassociated AP device 330 from at least the portion of the training signal transmitted by that unassociated AP device 330, and estimates link quality for the associated AP device 310 from the portion of the training signals transmitted by the associated AP device 310 and from the history of past transmissions to and receptions from the associated AP device 310.

The non-AP device STA 320 subsequently configures a transmission, for example a frame containing a measurement report, which it determines can be received and decoded by at least the unassociated AP device 330. The configuration of this transmission is based at least on the estimated link quality to the unassociated AP device 330. For example, the non-AP device STA 320 may configure the transmission according to the weaker of the links to the associated and unassociated AP device 330s. By contrast, in conventional approaches, the non-AP device STA 320 may configure the transmission based on link quality estimated from all antenna ports of the training signals, thereby producing an estimate that is typically better than even the link quality of the associated AP device 310, or based on the history of past transmissions and receptions with the associated AP device 310.

In some embodiments, the training signal may be transmitted entirely by the unassociated AP device 330. In that case, the non-AP device STA 320 uses the entire training signal, including all antenna ports, to estimate the link quality to the unassociated AP device 330. In other scenarios, the trigger may indicate that at least a portion of the training signals is transmitted by an unassociated AP device 330 but may not identify the specific portion or antenna ports. In that case, the non-AP device STA 320 may estimate the quality of the weakest link, or the link to the unassociated AP device 330, from the S weakest antenna ports, with S being a preconfigured parameter, for example S=2 or S=1. The weakest antenna ports may be defined as those with the lowest average SNR or RSS.

When the non-AP device STA 320 knows the identity of the unassociated AP device 330, it may also estimate link quality to the unassociated AP device 330 from other signals, such as recently transmitted beacons, in addition to or instead of estimating link quality from the portion of the training signal transmitted by the unassociated AP device 330. However, it may be preferable for the non-AP device STA 320 to estimate link quality from the training signals when those signals provide the most recent estimate.

Although FIG. 3 illustrates an example of a process 300 for receiving a trigger to perform a measurement, various changes may be made to FIG. 3. For example, various components of FIG. 3 could be combined, further subdivided, or omitted and additional components could be added according to particular needs.

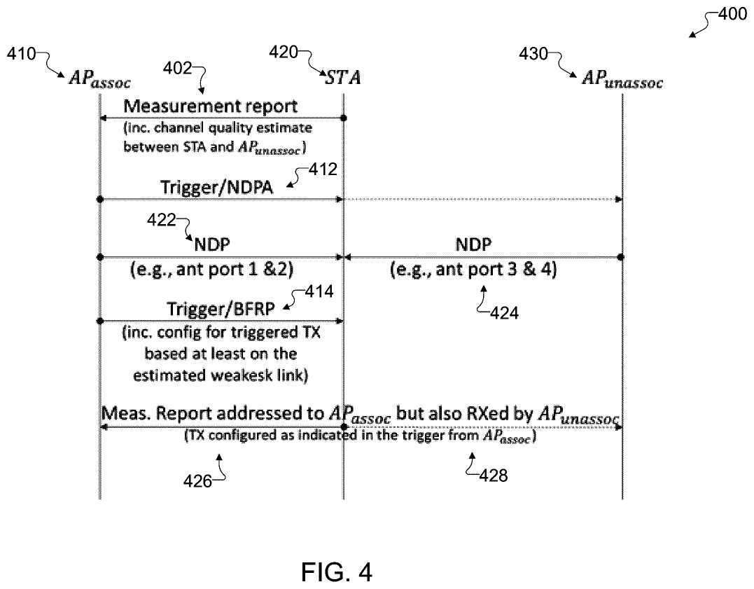

FIG. 4 illustrates an example process 400 for an associated AP device configuring a trigged transmission according to embodiments of the present disclosure. For ease of explanation, the process 400 will be described as including one or more components of the wireless network 100 of FIG. 1; however, the process 400 could be implemented using any other suitable device or system. The embodiment of the process 400 shown in FIG. 4 is for illustration only. Other embodiments of the process 400 could be used without departing from the scope of this disclosure.

As shown in FIG. 4, the process 400 includes an associated AP device 410, a non-AP device 420, and an unassociated AP device 430. The non-AP device 420 transmits a measurement report 402 to the associated AP device 410 that includes channel quality estimates between the unassociated AP device 430 and the non-AP device 420. Alternatively, the associated AP device 410 may receive a measurement report (not shown) from the unassociated AP device 430, where the report includes an indication of channel quality estimate between the unassociated AP device 430 and the non-AP device 420. The associated AP device 410 transmits a first trigger frame 412 to the non-AP device 420. The associated AP device 410 addresses at least a portion of the first trigger frame 412 to the unassociated AP device 430. In response, the non-AP device 420 may then receive a first training signal 422 from the associated AP device 410 and a second training signal 424 from the unassociated AP device 430. The associated AP device 410 may then transmit a second trigger frame 414, such as a frame that includes configurations for triggered transmission based at least on the estimated weakest link. Once the non-AP device 420 receives the second trigger frame 414, the non-AP device 420 may then transmit a measurement report 426 to the associated AP device 410 and shown as 428 when being received at the unassociated AP device 430, respectively.

The associated AP device 410 sends a trigger to the non-AP device 420 to initiate a frame transmission. The frame transmission is depicted as a measurement report 426, 428 based on the preceding null data packet announcement (NDPA) and null data packet (NDP) transmissions, and both the associated AP device 410 and the unassociated AP device 430 attempt to receive and decode the measurement report 426, 428. More generally, the frame transmission 426, 428 from the non-AP device 420 may be any frame that both the associated AP device 410 and the unassociated AP device 430 intend to receive and decode.

When the associated AP device 410 determines that an unassociated AP device 430 may also seek to receive and decode the triggered frame, the associated AP device 410 configures the triggered frame accordingly. For example, the associated AP device 410 uses a previously reported channel quality estimate between the non-AP device 420 and the unassociated AP device 430 to configure the triggered transmission. In addition, the associated AP device 410 may also use the channel estimate between itself and the non-AP device 420. For example, the associated AP device 410 may configure the triggered transmission based on the weaker of the two links, namely the associated AP device 410—non-AP device 420 link and the unassociated AP device 430—non-AP device 420 link. The associated AP device 410 then sends the configuration to the non-AP device 420 in a trigger frame, such as in the second trigger frame 414.

Although FIG. 4 illustrates an example process 400 for an associated AP device configuring a trigged transmission, various changes may be made to FIG. 4. For example, various components of FIG. 4 could be combined, further subdivided, or omitted and additional components could be added according to particular needs.

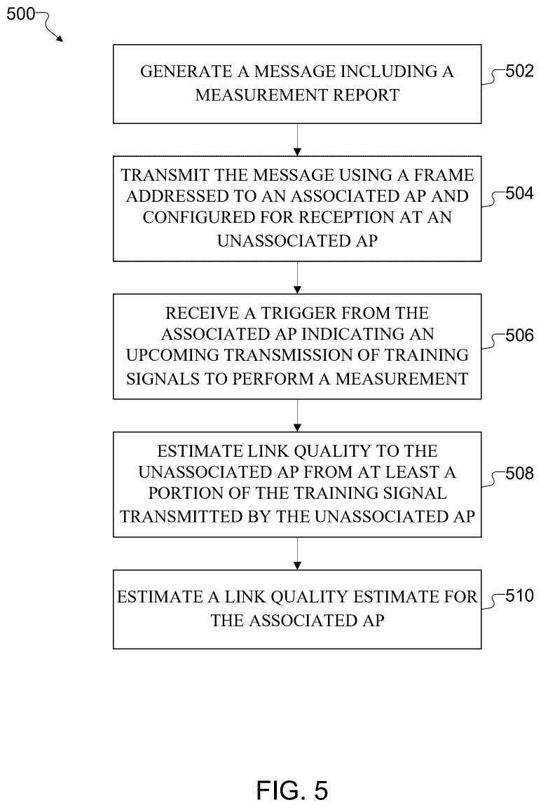

FIG. 5 illustrates an example method 500 for wireless communication performed by a non-AP device according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for wireless communication could be used without departing from the scope of this disclosure.

As shown in FIG. 5, a message is generated including a measurement report at step 502. For example, the non-AP device 420 may generate a measurement report 426, 428 for transmission. When the non-AP device 420 determines that a frame it intends to transmit can be received and decoded by its associated AP device 410 and by one or more unassociated AP devices 430, the non-AP device 420 configures the transmission to reflect that determination and transmits the frame accordingly. Alternatively, the associated AP device 410 may trigger the non-AP device 420 to transmit a frame. In that case, the associated AP device 410 determines that the triggered frame is to be received and decoded by both the associated AP device 410 and one or more unassociated AP devices 430. The AP device then configures the triggered transmission based on that determination and conveys the configuration to the non-AP device 420 in the trigger frame. The non-AP device 420 applies the received configuration to its triggered transmission in the usual manner. In this triggering scenario, the AP device provides the non-AP device 420 with a configuration selected to ensure successful reception and decoding by the associated AP device 410. However, when the AP device determines that an unassociated AP device 430 also needs to receive the triggered transmission, for example for coordinated beamforming between the associated and unassociated AP devices 430, the AP device selects a different configuration to support successful decoding by both AP devices.

The message is transmitted using a frame addressed to the associated AP device and configured for reception at the unassociated AP device at step 504. For example, the frame may be addressed to the associated AP device 410. For example, it may be addressed exclusively to the associated AP device 410 and not to the unassociated AP device 430. In other cases, the frame may be addressed to one of the AP devices among those that the non-AP device 420 determines are able to receive and decode the frame.

A trigger is received from the associated AP device at step 506. For example, the trigger indicating an upcoming transmission of training signals to perform a measurement, where at least part of the training signals are transmitted by the unassociated AP device 430. The training signals may come from multiple antenna ports. A first portion of the training signals are transmitted by the associated AP device 410. A second portion of the antenna ports are transmitted by the unassociated AP device 430. The trigger may indicate correspondence between the associated AP device 410 and the unassociated AP device 430.

The frame may include a measurement report, for example channel state information (CSI), channel quality indication (CQI), or channel busy ratio (CBR). The measurement may be based on reference or training signals where at least part of the signal is transmitted by an unassociated AP device 430. In some cases, all training signals are transmitted by the unassociated AP device 430. In other cases, at least part of the signal is transmitted by the associated AP device 410. For example, the training signals may be transmitted in a Null Data Packet (NDP). The training signal may include multiple antenna ports or spatial streams. A subset of antenna ports of the training signal may be transmitted by the associated AP device 410 and a non-overlapping subset may be transmitted by the unassociated AP device 430. In some cases, all antenna ports are transmitted by the unassociated AP device 430.

The non-AP device 420 estimates the channel based on the training signal and configures its transmission at least in part based on the estimated channel. For example, if training signals are transmitted by both the associated AP device 410 and the unassociated AP device 430, such as the first training signal 422 and the second training signal 424, the non-AP device 420 may form two channel quality estimates and configure its transmission based on the weaker channel. Because the channel to the unassociated AP device 430 is often weaker, the non-AP device 420 may base its configuration on the quality of the wireless channel to the unassociated AP device 430. In the case of a UHR NDPA frame, a special information field may be addressed to the unassociated AP device 430 that is participating in cross-BSS sounding and that will transmit at least a portion of the NDP for the non-AP device 420 to measure.

The information field addressed to the unassociated AP device 430 configures the unassociated AP device 430's NDP transmission, for example which spatial streams or antenna ports of the NDP the unassociated AP device 430 will transmit. By parsing this information field, the non-AP device 420 may determine which spatial streams or antenna ports are transmitted by the unassociated AP device 430 and which, if any, are transmitted by the associated AP device 410. The non-AP device 420 can then form an individual channel estimate for each AP device participating in the NDP transmission. If the non-AP device 420 does not know which antenna ports or spatial streams are transmitted by which AP device, it may use the weakest S spatial streams, for example S equals 2, to configure the transmission. For example, if the training signals are transmitted exclusively by the unassociated AP device 430, the non-AP device 420 estimates the channel quality to the unassociated AP device 430 and configures the transmission at least in part based on that estimated quality.

In a trigger-based transmission where the associated AP device 410 configures transmission of the non-AP device 420, the associated AP device 410 may select the configuration based on one or more previously reported channel quality measurements provided by the non-AP device 420, including an estimate of the channel between the non-AP device 420 and the unassociated AP device 430. In the absence of any such reports, the associated AP device 410 may configure the transmission conservatively, for example by selecting a lower modulation and coding scheme (MCS) index than would be needed for the associated link, so that the unassociated AP device 430 has a higher likelihood of successfully receiving and decoding the frame.

The scenario described above involves the non-AP device 420 transmitting a frame, such as a measurement report, after receiving training signals from at least the unassociated AP device 430, estimating the channel quality to the unassociated AP device 430, and configuring the transmission at least in part based on that estimate. More generally, when the non-AP device 420 does not receive training signals such as those in an NDP from the unassociated AP device 430, the non-AP device 420 may estimate the channel quality to the unassociated AP device 430 using other sources such as recent beacon frames or other reference signals transmitted by the unassociated AP device 430 and received by the non-AP device 420. As before, the non-AP device 420 then configures its transmission at least in part based on the estimated channel quality to the unassociated AP device 430.

Configuring a transmission may include determining one or more of the MCS, transmit power, and transmit precoding. Conventionally, the non-AP device 420 selects the MCS based on the estimated channel quality to the associated AP device 410, which is the addressed receiver. However, when the non-AP device 420 determines that the frame, although addressed to the associated AP device 410, may also be received and decoded by the unassociated AP device 430, for example to support multi-AP device coordination for coordinated beamforming, the non-AP device 420 configures the transmission to increase the likelihood of successful decoding by both AP devices. For example, the non-AP device 420 may configure the transmission based on the weaker of the links to the associated AP device 410 and unassociated AP devices 430.

A link quality to the unassociated AP device 430 is estimated from at least a portion of the training signal transmitted by the unassociated AP device 430 at step 508. For example, if the non-AP device 420 determines from the link quality to the associated AP device 410 that an MCS index of 4 would be suitable for high-likelihood reception at the associated AP device 410, the conventional approach would be to use MCS 4.

A link quality for the associated AP device 410 is estimated at step 510. For example, estimating a link quality for the associated AP device 410 from the training signals transmitted by the associated AP device 410, from the past transmissions to the associated AP device 410, or receptions from the associated AP device 410. If the non-AP device 420 also determines that the link quality to the unassociated AP device 430 suggests MCS 2 is more suitable and that MCS 4 would be too likely to fail at the unassociated AP device 430, then under the approach disclosed here the non-AP device 420 selects MCS 2. In the trigger-based case, the associated AP device 410 that triggers the non-AP device 420's transmission may apply the same techniques when configuring the non-AP device 420's transmission.

The non-AP device 420 may determine that its transmission can be received by an unassociated AP device 430, in addition to the associated AP device 410, in several ways. The non-AP device 420 may infer this from the trigger frame that initiated the transmission. For example, the associated AP device 410 may send a trigger instructing the non-AP device 420 to perform a measurement and later report it, and the trigger may indicate that the training signals on which to perform the measurement will be transmitted at least in part by an unassociated AP device 430. More generally, when the non-AP device 420 transmits in response to a trigger from the associated AP device 410, the trigger may indicate that an unassociated AP device 430 will attempt to receive and decode the transmission.

For example, if a UHR NDPA frame is used to initiate cross-BSS sounding, the NDPA may include an information field with a preconfigured association identifier to identify such an NDPA. Therefore, when the non-AP device 420 transmits a measurement report based on the subsequent NDP, it may assume that an unassociated AP device 430 may receive and decode the report. In addition, the unassociated AP device 430 may be identified by the identifier in the special information fields addressed to the unassociated AP device 430 participating in cross-BSS sounding. The non-AP device 420 may also draw this conclusion from the content of the training signals. For example, when the non-AP device 420 reports a measurement on training signals that include more antenna ports or spatial streams than the associated AP device 410 is known to have, the non-AP device 420 may assume that the frame containing the measurement report can be received and decoded by at least one unassociated AP device 430.

More generally, if the number of antenna ports or spatial streams in the training signals exceeds a configured threshold, the non-AP device 420 may assume that a transmission containing a measurement report based on those training signals will be received and decoded by at least one unassociated AP device 430. For example, an announcement from the associated AP device 410 of such training signals may implicitly indicate that at least part of the training signals will be transmitted by an unassociated AP device 430. The non-AP device 420 may also determine this based on the type of frame being transmitted. For example, certain frames are used for multi-AP device coordination, and when the non-AP device 420 transmits those frames under certain conditions, it may assume that an unassociated AP device 430 will also attempt to receive and decode the frame. The identity of the unassociated AP device 430 may be determined from the configuration of the multi-AP device coordination scheme.

Although FIG. 5 illustrates one example method for wireless communication, various changes may be made to FIG. 5. For example, while shown as a series of steps, various steps in FIG. 5 could overlap, occur in parallel, occur in a different order, or occur any number of times. The steps 506 to 510 may be first followed by steps 502 to 504.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point (AP) device, comprising:
a transceiver configured to form a link with an associated access point (AP) and a link with an unassociated AP device; and
a processor operably coupled to the transceiver, the processor configured to generate a message including a measurement report,
wherein the transceiver is further configured to transmit, to the associated AP device and the unassociated AP device, the message using a frame addressed to the associated AP and configured for reception at the unassociated AP device.

2. The non-AP device of claim 1, wherein the transceiver is configured to receive a trigger from the associated AP device, the trigger indicating an upcoming transmission of training signals to perform a measurement, wherein at least part of the training signals are transmitted by the unassociated AP device.

3. The non-AP device of claim 2, wherein:
the training signals are from multiple antenna ports;
a first portion of the training signals are transmitted by the associated AP device;
a second portion of the training signals are transmitted by the unassociated AP device; and
the trigger indicates correspondence between the associated AP and the unassociated AP.

4. The non-AP device of claim 2, wherein the processor is configured to estimate link quality to the unassociated AP device from at least a portion of the training signal transmitted by the unassociated AP device.

5. The non-AP device of claim 2, wherein the processor is configured to estimate a link quality estimate for the associated AP device from the training signals transmitted by the associated AP device.

6. The non-AP device of claim 2, wherein the processor is configured to estimate a link quality estimate for the associated AP device from the past transmissions to the associated AP or receptions from the associated AP device.

7. The non-AP device of claim 1, wherein the frame is transmitted based on at least an estimated link quality to the unassociated AP device.

8. An associated access point (AP) device, comprising:
a transceiver configured to form a link with a non-AP device; and
a processor operably coupled to the transceiver, the processor configured to configure the non-AP device for transmission to an unassociated AP device,
wherein at least one of the transceivers is further configured to receive, from the non-AP device, a message in a frame addressed to the associated AP device and configured for reception at the unassociated AP device.

9. The associated AP device of claim 8, wherein the transceiver is configured to transmit a trigger to the non-AP device, the trigger indicating an upcoming transmission of training signals to perform a measurement, wherein at least part of the training signals are transmitted by the unassociated AP device.

10. The associated AP device of claim 9, wherein:
the training signals are from multiple antenna ports;
a first portion of the training signals are transmitted by the associated AP device;
a second portion of the training signals are transmitted by the unassociated AP device; and
the trigger indicates correspondence between the associated AP and the unassociated AP device.

11. The associated AP device of claim 8, wherein the processor, to configure the non-AP device for transmission to the unassociated AP device, is configured to select a configuration based on one or more previously reported channel quality measurements provided by the non-AP device.

12. The associated AP device of claim 8, wherein the processor, to configure the non-AP device for transmission to the unassociated AP device, is configured to select a modulation and coding scheme (MCS) index for the non-AP device based on an estimated link quality to the unassociated AP.

13. The associated AP device of claim 9, wherein the processor, to configure the non-AP device for transmission to the unassociated AP device, is configured to configure the non-AP device for transmission based on a weaker of links to the associated AP device and the unassociated AP device.

14. The associated AP device of claim 8, wherein the frame is transmitted based on at least an estimated link quality to the unassociated AP device.

15. A method of wireless communication performed by a non-access point (AP) device, the method comprising:
generating, by the non-AP device, a message including a measurement report, wherein the non-AP device comprises a transceiver configured to form a link with an associated AP device and a link with an unassociated AP device; and
transmitting, to the associated AP device and the unassociated AP device, the message using a frame addressed to the associated AP device and configured for reception at the unassociated AP device.

16. The method of claim 15, further comprising:
receiving a trigger from the associated AP device, the trigger indicating an upcoming transmission of training signals to perform a measurement, wherein at least part of the training signals are transmitted by the unassociated AP device.

17. The method of claim 16, wherein:
the training signals are from multiple antenna ports;
a first portion of the training signals are transmitted by the associated AP device;
a second portion of the training signals are transmitted by the unassociated AP device; and
the trigger indicates correspondence between the associated AP device and the unassociated AP device.

18. The method of claim 16, further comprising:
estimating link quality to the unassociated AP device from at least a portion of the training signal transmitted by the unassociated AP device.

19. The method of claim 16, further comprising:
estimating a link quality estimate for the associated AP device from the training signals transmitted by the associated AP device, from the past transmissions to the associated AP device, or receptions from the associated AP device.

20. The method of claim 15, wherein the frame is transmitted based on at least an estimated link quality to the unassociated AP device.
